(19) United States
(12) Patent Application Publication
(10) Pub. No.: US 2002/0116259 A1
(43) Pub. Date: Aug. 22, 2002

(54) Online banner advertisement methods, systems and articles-of-manufacture

(76) Inventor: Hiroshi Matsuo, New York, NY (US)

Correspondence Address: Hopgood, Calimafde, Judlowe & Mondolino, LLP, 60 East 42nd Street, New York, NY, 10165, US

(21) Appl. No.: 09/785,622

(22) Filed: Feb. 16, 2001

(51) Int. Cl. G06F 17/60

(52) U.S. Cl. 705/14; 705/26

(57) ABSTRACT

The present invention relates to methods, apparatus and articles of manufacture for increasing the effectiveness of online advertising. One aspect of the present invention provides displaying an online advertisement to a user; determining whether or not the user should receive a prize in response to the users engagement of the online advertisement; and upon determining that the user should receive a prize, collecting information from the online user and using the information to award the prize.

### FIELD OF THE INVENTION

The present invention relates generally to methods, apparatus and articles-of-manufacture for use in connection with online, including Internet-based, commerce and advertising. More particularly, the invention relates to methods, apparatus and articles-of-manufacture intended to increase the click number of an online advertisement which is displayed on a WWW browser.

### BACKGROUND OF THE INVENTION

Online advertisement is widely used on the Internet. When using online advertisement, the sponsor typically sets a banner to connect a client terminal and the site which the sponsor manages to a document (or Web page) of the another person on the WWW. When such banner is clicked, a client terminal and the site of the sponsor are connected, and the screen of the page which the sponsor provides to the client terminal is displayed at the user's terminal or workstation.

The problem with traditional Internet banner advertising is that users have no motivation to click on the displayed banners and, in fact, will often intentionally avoid clicking on such banners.

From the perspective of Internet advertisers and their clients, there remains a significant need for improved methods, apparatus and articles-of-manufacture that encourage Internet users to click on advertising banners. The present invention satisfies, at least in part, this need.

### OBJECTS AND SUMMARY OF THE INVENTION

In light of the above, one general object of the invention relates to methods, apparatus and/or articles-of-manufacture to increase the click number of online banner advertisements.

Another general object of the invention relates to methods, apparatus and articles-of-manufacture for utilizing a prize contest or lottery to motivate online users to click on banner advertisements.

These, as well as other, objects and advantages of the present invention are provided by a system/method/article-of-manufacture through which the drawing of a prize, or entry into a lottery for a prize, is done when an online advertisement (such as a banner) is clicked.

Accordingly, generally speaking, and without intending to be limiting, aspects of the invention relate to methods, apparatus and/or articles-of-manufacture for increasing the effectiveness of online advertising by, for example, the following: displaying an online advertisement to an online user; determining, in response to the user's clicking or engagement of the online advertisement, whether or not the online user should receive a prize; and upon determining that the online user should receive a prize, collecting information from the online user and using said information to award the prize. Determining whether the online user should receive a prize preferably involves generating a random number. Collecting information may include collecting a name and postal address, which may be used to award the prize by delivering the prize to the postal address. Collecting information may also involve collecting an e-mail address, which may be used to award the prize by transmitting digital media to said e-mail address.

The invention may also involve determining said online user's eligibility for a prize by determining whether said user has previously been considered for a prize within a predetermined time period. In so doing, the system is preferably configured so that when the number of the clicks at the identical client terminal in a predetermined period exceeds a preset number, the system will not hold the drawing of the prize. By making such limitation, the fairness to the drawing of the prize will not be compromised.

### BRIEF DESCRIPTION OF THE DRAWINGS

Various aspects of the present invention are depicted in the accompanying set of drawings, which is intended to be exemplary rather than limiting, and in which:

FIG. 1 is the block diagram showing an exemplary implementation of the online advertisement system in accordance with the invention;

FIG. 2 shows an exemplary WWW page containing an exemplary banner advertisement;

FIG. 3 contains a flowchart of an exemplary process in accordance with the present invention; and,

FIG. 4 shows an exemplary message announcing that a user (who clicked on a banner advertisement) has won a prize.

### DESCRIPTION OF THE PREFERRED EMBODIMENTS(S)

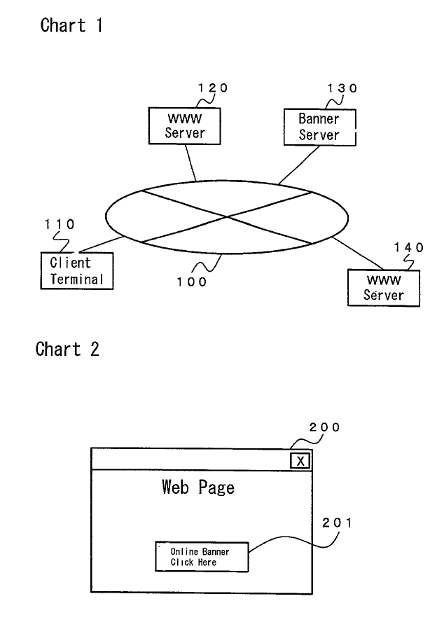

Hereinafter, explanations refer to a drawing about the form of the implementation of the online advertisement system according to the present invention. Reference is initially made to FIG. 1, which shows a block diagram of an exemplary implementation of the online advertisement system according to this invention. In the implementation which is shown in FIG. 1, client terminal 110, WWW server 120, banner serverl30 and WWW server 140 are connected with Internet 100. Client terminal 110 is the terminal which is used by the user and is associated with a personal computer or other devices. A WWW browser, which is the software which reads a document on the WWW through Internet 100, is beforehand incorporated into client terminal 110. WWW server 120 and WWW server 140 provide the Internet 100 a web page.

Banner server 130 accumulates information. Banner server 130 may be incorporated into WWW server 120 or WWW server 140. WWW server 120 and WWW server 140 are managed by the businesses or individuals. WWW server 120 provides web page 200 as shown in FIG. 2 for the Internet 100. Banner 201 is provided on web page 200 to make the web page of the sponsor and client terminal 110 connect. The web page of the sponsor is provided by WWW server 140.

Hereinafter, the management person of WWW server 120 is called a web page provider and the management person of WWW server 140 is called a sponsor.

The control program which controls web page 200 in the display is incorporated into WWW server 120. WWW server 120 controls web page 200 through a control program. The control program, which processes a prize drawing when controlling banner 201 of web page 200 in the display is clicked, is incorporated into banner server 130. Banner server 130 controls banner 201 in the display by being ordered by the control program. Also, it processes a prize drawing when banner 201 is clicked.

Banner server 130 contains instructions for conducting the prize drawing. Also, the control program may be loaded into WWW server 120 from a computer-readable medium, such as a CD-ROM or floppy disk.

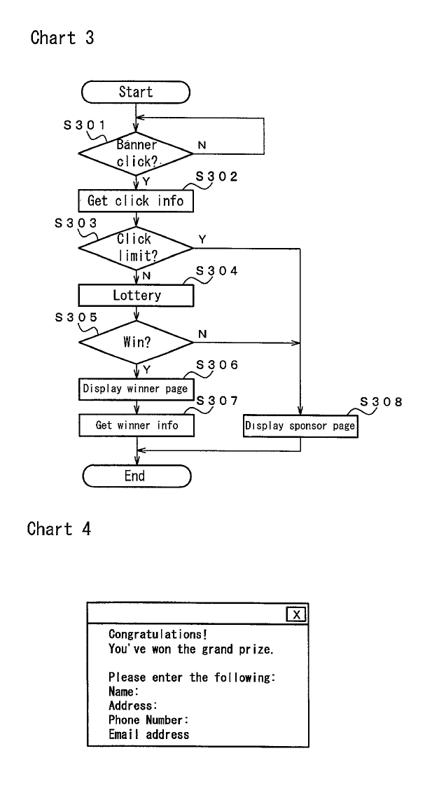

Reference is now made to FIG. 3, which is a flowchart that depicts the operation of the exemplary online advertisement system according to the invention. The user first accesses web page 200 using client terminal 110. (That is, he/she makes client terminal 110 and WWW server 120 connect.) The user then accesses URL of web page 200 to make a WWW browser start on client terminal 110 and inputting it onto the browser. The screen of web page 200 is then displayed at client terminal 110. Next, the user clicks (preferably by a mouse operation) banner 201, which is provided by home page 200. (Alternatively, the client may choose banner 201 by the keyboard operation and so on.) When banner 201 is clicked (step S301), the browser of client terminal 110 becomes connected with banner server 130 by sending out a URL which corresponds to the banner advertisement in Internet 100. Banner server 130 requires a connection which uses an SSL (Secure Socket Layer) when connecting. Therefore, it is possible for the true IP address of client terminal 110 to be acquired by banner server 130 when there is access from client terminal 110. Therefore, the user cannot use a program which has a purpose of making false representation of the transmitter terminal IP address. That is, it isn't possible to make banner server 130 think that the client is using a terminal other than client terminal 110. Also, because banner server 130 is automatically able to retrieve the IP address of client terminal 110, the user doesn't have to register beforehand the individual information which contains an IP address in banner server 130 in order to participate in the prize drawing.

Banner server 130 also accumulates the date and time when the banner was clicked with the IP address of client terminal 110 as the click information (Step S302). Banner server 130 judges whether or not clicks from the client terminal 110 exceeded the number of the set times in the predetermined time before prize drawing occurs based on the click information (Step S303). That is, it determines whether or not the click number of banner 201 at the identical client terminal in fixed time was limited and whether or not the number of the clicks crossed this limitation. For example, if one click is allowed every one minute, banner server 130 judges whether there had been a click at client terminal 110 by within the past one minute at the identical client terminal 110. It is impossible to disguise the true IP address and is therefore difficult for the user to try to break above-mentioned temporal limitation in client terminal 110. This is because the true IP address of client terminal 110 is proved by the SSL protocol in banner server 130, as is mentioned above. As a result, when judging that the number of the clicks exceeded the preset number, banner server 130 processes to display the screen of the web page which the sponsor provides client terminal 110 (Step S308). In this case, it does the processing to display the web page which WWW server 140 provides. It also causes banner server 130 to transmit the IP address of client terminal 110 to WWW server 140 and causes WWW server 140 to display the home page of the sponsor at client terminal 110 based on the IP address.

If it is determined that the number of the clicks doesn't exceed the preset number (as in step S303), banner server 130 holds the drawing of the prize (Step S304). It holds a drawing by producing a random number and extracting a random number from its process. Then, banner server decides whether or not the client is elected a winner as a result of the drawing (Step S305). It decides whether the client is a winner by comparing the preset winning number and the extracted random number. For example, when the winning number and the random number match, it decides the client to be the winner.

If the client is judged to be a loser, banner server 130 executes the processing of step S308. When won as a result of the drawing, banner server130 displays the contents (FIG. 4) of the page for the winner at client terminal 110 (Step S306). That is, banner server 130 transmits the information to display a page for the winner to client terminal 110. The user then inputs the information which is necessary to receive a prize on the page for the winner (Step S307). For example, he/she inputs his/her name, telephone number, E-mail address and postal address. Then, a prize provision person delivers a prize to the user based on the inputted information.

In case of the prize being goods or currency ( e.g., a check), the prize is delivered based on the address of the winner. Alternatively, when the prize is digital musical content or digital picture contents which is transmitted through Internet 100, it refers to the E-mail address of the winner and it transmits these contents. Also, although not illustrated, it is good to display (step S308) the page of the sponsor at client terminal 110 after the processing with step S307 ends.

Because of the chance of winning a prize, one can expect the click rate of online advertisement to increase. Therefore, an increase of the click number of banner 201 can be expected and the improvement of the advertisement effectiveness by the online advertisement can be expected. By the increase of the click number of banner 201, it is possible to have an increase in the number of users who see the page of the sponsor site.

If a client clicks on the same banner more than once, the drawing process will preferably not be initiated after the first click. Incidentally, in the implementation which was described above, only one prize (the grand prize) was implied, using the case to explain the system as an example, but more than one prize may be supplied (2nd prize, 3rd prize and so on) besides the grand prize. In this case, one number can be predetermined per prize, and if the random number matches any of the numbers, the client will win the respective prize. Also, odds of winning can be controlled and set for various types of prizes. For example, a grand prize is won once every 100,000 clicks, whereas the supplementary prize (the 2nd prize) may be won every 50,000 clicks. In this case, the difference can be realized by putting a different number of winning numbers for the grand prize and the supplementary prize(s).

Also, banner server 130 skips the drawing of the prize when it confirms the stock of the prize and if all prizes are judged to have been already won by the winners. It will display the screen of the web page of the sponsor at client terminal 110 (Step S308). Also, when the part or all of the prepared prizes are won, the prize provision person may add a prize.

Accordingly, those skilled in the art will recognize that the online advertisement which is provided for the page on the WWW according to this invention is more likely to be clicked, because the drawing of the prize. Therefore, it is reasonable to expect that the number of the clicks will increase.

While the foregoing has described the invention by recitation of its various aspects/features and an illustrative embodiment thereof, those skilled in the art will recognize that alternative elements and techniques, and/or combinations and sub-combinations of the described elements and techniques, can be substituted for, or added to, those described herein. The present invention, therefore, should not be limited to, or defined by, the specific apparatus, methods, and articles-of-manufacture described herein, but rather by the appended claims, which are intended to be construed in accordance with well-settled principles of claim construction, including, but not limited to, the following:

Limitations should not be read from the specification or drawings into the claims (e., if the claim calls for a “chair,” and the specification and drawings show a rocking chair, the claim term “chair” should not be limited to a rocking chair, but rather should be construed to cover any type of “chair”).

The words “comprising,” “including,” and “having” are always open-ended, irrespective of whether they appear as the primary transitional phrase of a claim, or as a transitional phrase within an element or sub-element of the claim (e., the claim “a widget comprising: A; B; and C” would be infringed by a device containing 2A's, B, and 3C's; also, the claim “a gizmo comprising: A; B, including X, Y, and Z; and C, having P and Q” would be infringed by a device containing 3A's, 2X's, 3Y's, Z, 6P's, and Q).

The indefinite articles “a” or “an” mean “one or more”; where, instead, a purely singular meaning is intended, a phrase such as “one,” “only one,” or “a single,” will appear.

Where the phrase “means for” precedes a data processing or manipulation “function,” it is intended that the resulting means-plus-function element be construed to cover any, and all, computer implementation(s) of the recited “function” using any standard programming techniques known by, or available to, persons skilled in the computer programming arts.

A claim that contains more than one computer-implemented means-plus-function element should not be construed to require that each means-plus-function element must be a structurally distinct entity (such as a particular piece of hardware or block of code); rather, such claim should be construed merely to require that the overall combination of hardware/firmware/software which implements the invention must, as a whole, implement at least the function(s) called for by the claims.

What is claimed is:

1. A method for promoting response to online advertising, comprising:
displaying an online advertisement to an online user;
determining, in response to the user's clicking or engagement of the online advertisement, whether or not the online user should receive a prize; and,
upon determining that the online user should receive a prize, collecting information from the online user and using said information to award the prize.

2. A method, as defined in claim 1, wherein determining whether the online user should receive a prize includes generating a random number.

3. A method, as defined in claim 1, wherein collecting information includes collecting a name and postal address.

4. A method, as defined in claim 3, wherein using said information to award the prize includes delivering the prize to the postal address.

5. A method, as defined in claim 1, wherein collecting information includes collecting an e-mail address.

6. A method, as defined in claim 5, wherein using said information to award the prize includes transmitting digital media to said e-mail address.

7. A method, as defined in claim 1, further comprising:
determining said online user's eligibility for a prize by determining whether said user has previously been considered for a prize within a predetermined time period.
